(19) United States
(12) Patent Application Publication
(10) Pub. No.: US 2026/0037875 A1
(43) Pub. Date: Feb. 5, 2026

(54) EDGE COMPUTING DEVICE AND METHOD OF OPTIMIZING DEEP LEARNING MODEL

(71) Applicant: Korea Electronics Technology Institute, Seongnam-si (KR)

(72) Inventors: Kyeong Eun SEO, Seoul (KR); Chang Mo YANG, Goyang-si (KR); Dong Chil KIM, Seoul (KR)

(21) Appl. No.: 19/355,318

(22) Filed: Oct. 10, 2025

Related U.S. Application Data
(63) Continuation of application No. PCT/KR2024/015092, filed on Oct. 4, 2024.

(30) Foreign Application Priority Data
Nov. 14, 2023 (KR) 10-2023-0157667

(51) Int. Cl. G06N 20/00; G06V 10/74; G06V 10/77; G06V 20/10

(52) U.S. Cl. CPC G06N 20/00; G06V 10/761; G06V 10/7715; G06V 20/10

(57) ABSTRACT

Proposed is a method of optimizing a deep learning model, which is performed by an edge computing device. The method may include measuring a similarity between data collected from an installation environment of the edge computing device and training data used for training a deep learning model installed in the edge computing device. The method may also include determining whether to perform optimization of the deep learning model based on a measurement result of the similarity. The method may further include generating training data for performing the optimization of the deep learning model based on reliability information, and training and generating a deep learning model based on the training data. The method may further include updating the existing deep learning model applied to the edge computing device with the generated deep learning model.

### CROSS REFERENCE TO RELATED APPLICATIONS

This is a continuation application of International Patent Application No. PCT/KR2024/015092 filed on Oct. 4, 2024, which claims priority to Korean patent application No. 10-2023-0157667 filed on Nov. 14, 2023, contents of each of which are incorporated herein by reference in their entireties.

### BACKGROUND

### Technical Field

The present disclosure relates to an edge computing device and a method of optimizing a deep learning model thereof.

### Description of Related Technology

Applying existing large-scale deep learning models directly to edge computing devices faces various limitations, such as constrained computing resources. To overcome these limitations, the existing deep learning models are being applied in lightweight forms, and when the deep learning models are created and applied in lightweight forms, surrounding environmental information, such as weather, may serve as useful information for providing stable performance.

### SUMMARY

One aspect is an edge computing device and a method for optimizing a deep learning model thereof to automatically adapt to various installation environments and optimize a weather classification deep learning model.

Aspects are not limited to those described herein, and other aspects may exist.

Another aspect is a method of optimizing a deep learning model, which is performed by an edge computing device, according to a first aspect of the present disclosure include: measuring a similarity between data collected from an installation environment of the edge computing device and training data used for training a deep learning model installed in the edge computing device; determining whether to perform optimization of the deep learning model based on a measurement result of the similarity; generating training data for performing the optimization of the deep learning model based on reliability information; training and generating a deep learning model based on the training data; and updating the existing deep learning model applied to the edge computing device with the generated deep learning model.

The deep learning model may be a weather classification deep learning model.

The measuring of the similarity between the data collected from the installation environment of the edge computing device and the training data used for training the deep learning model installed in the edge computing device may include: inputting an image collected from the installation environment into a weather classification deep learning model to extract a first feature vector; reducing dimensions of the first feature vector and mapping the dimensions onto a first feature space; and measuring a similarity by comparing information of the mapped first feature vector with information of a second feature vector stored in a feature space database that is built in advance.

The measuring of the similarity between the data collected from the installation environment of the edge computing device and the training data used for training the deep learning model installed in the edge computing device may include: inputting an image used in the training to the weather classification deep learning model to extract the second feature vector; reducing dimensions of the second feature vector and mapping the dimensions onto a first feature space; and storing information of the mapped second feature vector in the feature space database.

In the generating of the training data for performing the optimization of the deep learning model based on the reliability information, similarity-based ground-truth information is generated when the similarity the information between the first and second feature vectors satisfies a preset condition, and the training data is composed of the image collected from the installation environment, and the similarity-based ground-truth information including a classification class ground-truth label and reliability of the image.

In the generating of the training data for performing the optimization of the deep learning model based on the reliability information, the ground-truth label may directly use a ground-truth class of the training data that satisfies the preset condition, and as the reliability, reliability determined based on a maximum threshold value of relative entropy (KL-divergence) and a probability similarity of the first and second feature vectors may be applied.

The generating of the training data for performing the optimization of the deep learning model based on the reliability information may include: in the case of an operating condition of the edge computing device and a cloud server are, when the similarity does not satisfy the preset condition, inputting the image collected from the installation environment to the weather classification deep learning model trained with predetermined large-scale and multiple-domain-based training data from the cloud server to generate a K-dimensional (K is a natural number) feature vector, and comparing the K-dimensional feature vector with the first feature vector to generate ground-truth information based on a most similar feature vector.

The training and generating of the deep learning model based on the training data may include training the deep learning model based on a loss function that applies the reliability to a difference between the ground-truth label and a predicted value of the deep learning model.

The generating of the training data for performing the optimization of the deep learning model based on the reliability information may further include: setting weather information of a meteorological agency measured at a closest distance based on the installation environment as a meteorological agency information-based ground-truth label; calculating meteorological agency information-based reliability by applying distance information and a predetermined weight based on location information of the installation environment and location information corresponding to the closest distance; and generating the meteorological agency information-based ground-truth label and the meteorological agency information-based reliability as the meteorological agency information-based ground-truth information.

The training and generating of the deep learning model based on the training data may include: applying the reliability to the difference between the ground-truth label and the predicted value of the deep learning model; applying the meteorological agency information-based reliability to a difference between the meteorological agency information-based ground-truth label and the predicted value of the deep learning model; and training the deep learning model based on a loss function that sums up results of the application.

Another aspect is an edge computing device that includes: a communication module that collects data in an installation environment through a predetermined network; a memory that stores a program for training and generating a deep learning model; and a processor that executes the program stored in the memory. The processor may execute the program to measure a similarity between the data collected from the installation environment and the training data used for training the deep learning model, and when it is determined that optimization of the deep learning model is necessary as a measurement result of the similarity, training data for optimizing the deep learning model may be generated based on reliability information, and after training and generating a deep learning model based on the training data, the existing deep learning model may be updated with the generated deep learning model.

In addition, there may be further provided another method and another system for implementing the present disclosure and a computer-readable recording medium on which a computer program for executing the method is recorded.

### Advantageous Effects

According to one embodiment of the present disclosure described above, by automatically analyzing the installed environments, it is possible to support the optimized performance for the deep learning model in various environments.

In addition, by generating training data using various types of information and reliability measurements, it is possible to improve the quality of the deep learning model.

In addition, by generating the learning model reflecting the reliability to estimate the predicted reliability of the optimized learning model, it is possible to utilize the predictions through the deep learning model more reliably.

In addition, by automatically optimizing the deep learning model installed in the existing edge computing device, it is possible to implement stable weather classification even when the weather classification is performed in an environment different from the existing learning environment.

The effects of the present disclosure are not limited to the above-described effects, and other effects that are not mentioned may be obviously understood by those skilled in the art from the following description.

### BRIEF DESCRIPTION OF THE DRAWINGS

FIG. 1 is a flowchart of a deep learning model optimization method according to an embodiment of the present disclosure.

FIG. 2 is a diagram for describing a feature space configuration and similarity measurement process in an embodiment of the present disclosure.

FIGS. 3A and 3B are diagrams for describing a process of generating training data when there is no meteorological agency information in an embodiment of the present disclosure.

FIGS. 4A and 4B are diagrams for describing the process of generating training data when there is meteorological agency information in an embodiment of the present disclosure.

FIG. 5 is a block diagram of an edge computing device capable of optimizing a deep learning model according to an embodiment of the present disclosure.

### DETAILED DESCRIPTION

Examples of a method of collecting weather information may include a method of predicting based on a deep learning model or a method of utilizing data from a nearby meteorological agency.

A method of predicting weather using a deep learning model involves attempting to predict the weather using a pre-trained model. Such a method has the advantage of making existing large-scale deep learning models lightweight and allowing the large-scale deep learning models to be executed on an edge computing device. However, this method has a problem in terms of data dependency. That is, there is a problem in that the deep learning model depends on training data, and it is difficult to provide accurate predictions in weather patterns or situations that are not in the training data. In addition, since available resources are limited in the edge computing environment, there is a need to make models lightweight.

On the other hand, a method of utilizing surrounding weather information has the advantage of directly utilizing the information of the current environment. In this method, additional data does not need to be collected, and weather information may be obtained by utilizing existing weather information. However, this method has a problem in terms of accuracy due to the distance problem. That is, the accuracy of prediction may be reduced due to a difference in distance between the surrounding environment and the weather information measurement point, and terrain, buildings, natural obstacles, etc., may affect the prediction accuracy. In addition, the surrounding meteorological agency information may also face the problem of data reliability.

Advantages and features of the present disclosure and methods to achieve them will be elucidated from exemplary embodiments described below in detail with reference to the accompanying drawings. However, the present disclosure is not limited to embodiments to be described below, but may be implemented in various different forms, these embodiments will be provided only in order to make the present disclosure complete and allow those skilled in the art to completely recognize the scope of the present disclosure, and the present disclosure will be defined by the scope of the claims.

Terms used in the present specification are for explaining embodiments rather than limiting the present disclosure. Unless explicitly described to the contrary, a singular form includes a plural form in the present specification. Throughout this specification, the terms “comprise” and/or “comprising” will be understood to imply the inclusion of stated constituents but not the exclusion of any other constituents. Like reference numerals refer to like components throughout the specification and “and/or” includes each of the components mentioned and includes all combinations thereof. Although “first,” “second,” and the like are used to describe various components, it goes without saying that these components are not limited by these terms. These terms are used only to distinguish one component from other components. Therefore, it goes without saying that a first component mentioned below may be a second component within the technical scope of the present disclosure.

Unless defined otherwise, all terms (including technical and scientific terms) used in the present specification have the same meanings commonly understood by those skilled in the art to which the present disclosure pertains. In addition, terms defined in commonly used dictionaries are not ideally or excessively interpreted unless explicitly defined otherwise.

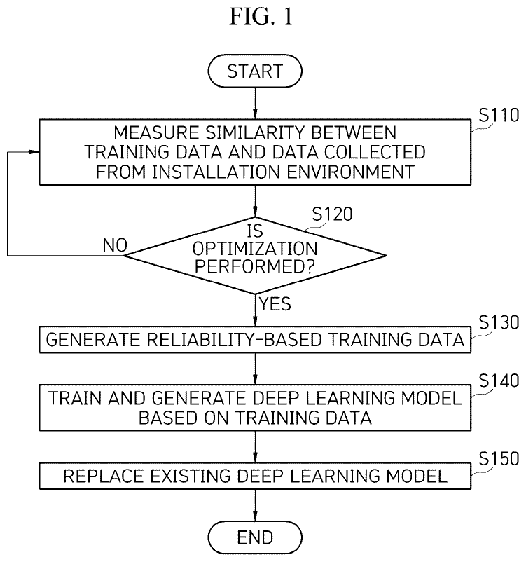

Hereinafter, a method of optimizing a deep learning model performed by an edge computing device 100 according to one embodiment of the present disclosure will be described with reference to FIGS. 1 to 4B.

FIG. 1 is a flowchart of a method of optimizing a deep learning model according to one embodiment of the present disclosure.

The method of optimizing a deep learning model including measuring a similarity between data collected from an installation environment of the edge computing device and training data used for training a deep learning model installed in the edge computing device (S110), determining whether to perform optimization of the deep learning model based on a measurement result of the similarity (S120), generating training data for performing the optimization of the deep learning model based on reliability information (S130), training and generating a deep learning model based on the training data (S140), and updating the existing deep learning model applied to the edge computing device 100 with the generated deep learning model (S150) is performed.

Meanwhile, each operation illustrated in FIG. 1 may be understood to be performed by the edge computing device 100 described below but is not necessarily limited thereto.

First, a similarity between the environment where the edge computing device 100 is installed and data used in the currently installed deep learning model is measured (S110). Then, it is determined whether to perform the optimization of the deep learning model according to the similarity measurement result (S120). In this case, the deep learning model in an embodiment of the present disclosure may be a deep learning model for weather classification (hereinafter, weather classification deep learning model).

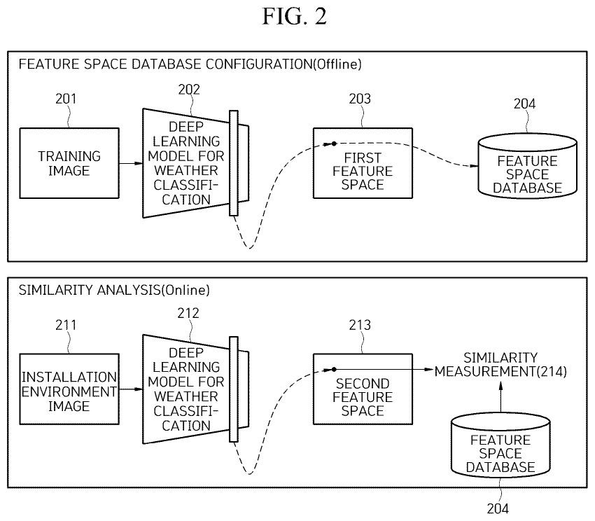

FIG. 2 is a diagram for describing a feature space configuration and similarity measurement process in an embodiment of the present disclosure.

In an embodiment, the similarity measurement involves measuring the similarity between feature space DB information of training data used in the deep learning model and an image of the current installation environment.

To this end, the image 201 used in training in advance is input into a weather classification deep learning model 202 to extract a feature vector. This is referred to as a second feature vector to distinguish it from a feature vector that will be described below. Then, the dimension of the second feature vector is reduced and mapped onto the second feature space 203, and the information of the mapped second feature vector is stored in the feature space database 204. This process may be repeated for the entire learning image to construct a feature space database.

The feature space database constructed in this way is pre-constructed in a general computing environment to reduce the load of the edge computing environment and reduce the feature space to an arbitrary N dimensions considering the edge computing environment, so that the feature space database may be utilized in various edge computing environments.

Next, for the similarity analysis, the collected image 211 in the installation environment is input to a weather classification deep learning model 212 to extract a first feature vector. Then, a dimension of the first feature vector is reduced and mapped onto a first feature space 213. Next, the similarity may be measured by comparing the information of the mapped first feature vector with the information of the second feature vector stored in the pre-constructed feature space database 204 (214).

In an embodiment, a Kullback-Leibler (KL) divergence method of measuring a difference between two probability distributions may be applied in the similarity measurement. In this case, the KL technique is used to measure a distance or a difference between two probability distributions P and Q, and the higher the value, the more the two distributions differ from each other.

Referring back to FIG. 1, next, training data for optimizing the deep learning model is generated based on reliability information (S130).

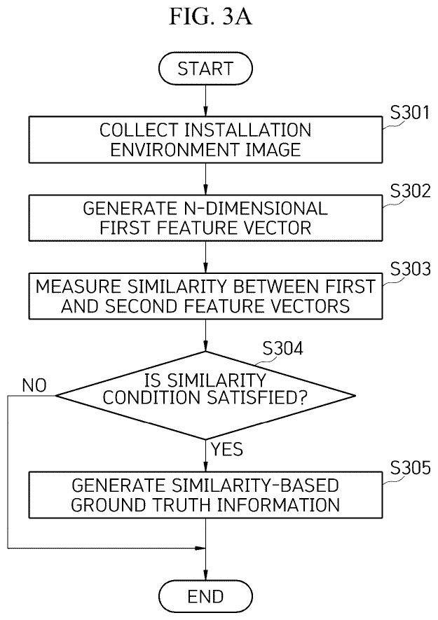

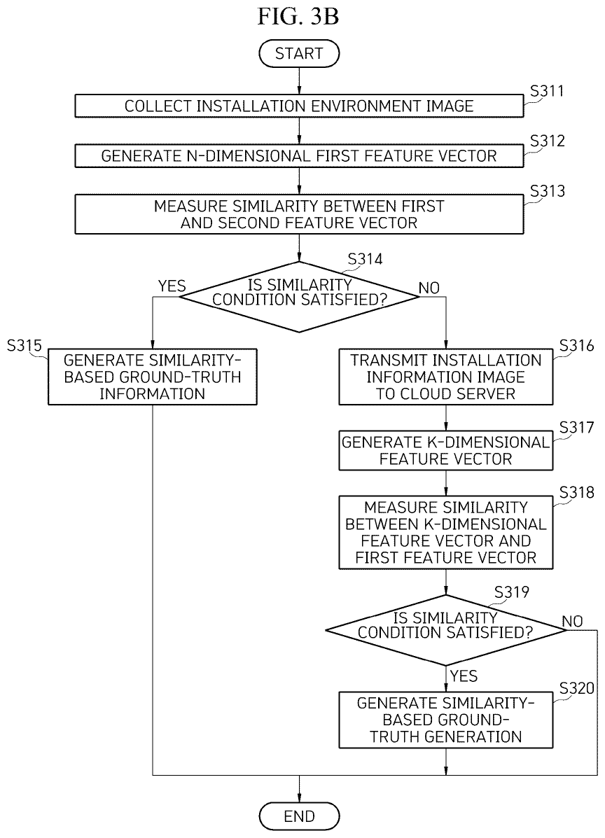

FIGS. 3A and 3B are diagrams for describing a process of generating training data when there is no meteorological agency information in an embodiment of the present disclosure.

In an embodiment, the reliability-based training data consists of an image I collected from an installation environment and a classification class ground-truth label L and reliability W of an image. In this case, the classification class ground-truth label L and the reliability W of the image correspond to similarity-based ground-truth information.

$$\begin{matrix}{Data}_{train} = [ I , L , W ] , \\ L = [ {label}_{KL} ] , \\ W = [ {w}_{KL} ]\end{matrix} \qquad EQUATION 1$$

Specifically, according to an embodiment of the present disclosure, a training data generation process operates differently according to either operating conditions of the edge computing device 100 environment (see FIG. 3A) or operating conditions of the edge computing device 100 and the cloud server environment (see FIG. 3B).

First, referring to FIG. 3A, an installation environment image I is collected (S301), and an N-dimensional feature vector (called a first feature vector) is generated using the weather classification deep learning model and the dimension reduction method (S302). Next, the similarity between the probability distributions (KL divergence) of the information of the generated first feature vector and the information of the second feature vector stored in the feature space database is measured (S303). This is as described in FIG. 2.

Next, it is determined whether the similarity of the information between the first and second feature vectors satisfies the preset conditions (S304), and when the determination result is that the conditions are satisfied, the ground-truth information based on the similarity may be generated (S305). In this case, the similarity conditions may be values arbitrarily set by an administrator in advance.

In this case, in the ground-truth information based on the similarity, a ground-truth label [label_{KL}] directly uses the ground-truth class of the training data that satisfies the similarity condition, and the reliability determined based on a maximum threshold value of the relative entropy (KL-divergence) and the probability similarity of the first and second feature vectors may be applied as the reliability [w_{KL}] as in Equation 2.

$${w}_{KL} = \{ \begin{matrix}\frac{{P}_{ma x} - {P}_{KL}}{{P}_{ma x}} , & ( {P}_{KL} \leq {P}_{ma x} ) \\ 0 , & ( {P}_{KL} > {P}_{ma x} )\end{matrix} \qquad EQUATION 2$$

In this case, in Equation 2, Pₘₐₓ denotes the maximum threshold of the KL divergence, P_{KL} denotes the probability similarity of the first and second feature vectors, and when it exceeds a certain threshold value, the reliability w_{KL} may be defined as 0. That is, according to an embodiment of the present disclosure, the above Equation 2 is an equation that restricts a value with a large similarity difference from being used for training.

Thereafter, when the ground-truth sheet generation is completed, the training data generation for the corresponding image is terminated.

Next, referring to FIG. 3B, in the case of the operating environment conditions of the edge computing device 100 and the cloud server, the process (S311 to S315) from the operation of collecting the installation environment image to the operation of checking whether the similarity of the information between the first and second feature vectors satisfies the preset conditions operates in the same manner as in FIG. 3A.

In contrast, when the similarity does not satisfy the preset conditions, the installation environment image is transmitted to the cloud server (S316), and the cloud server inputs the image collected from the installation environment based on the weather classification deep learning model to generate a K-dimensional feature vector (S317). In this case, the weather classification model of the cloud server may be a deep learning model trained with the training data configured based on predetermined large-scale and multiple domains.

Next, the similarity is measured by comparing the K-dimensional feature vector with the first feature vector (S318), and the ground-truth information may be generated based on the feature vector with the most similar measured similarity in operation S319 (S320). In this case, operations S319 and S320 are the same as operations S304 and S305 in FIG. 3A described above.

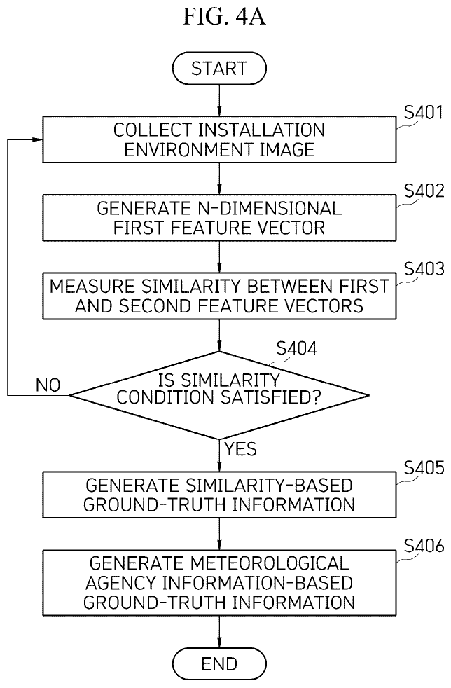

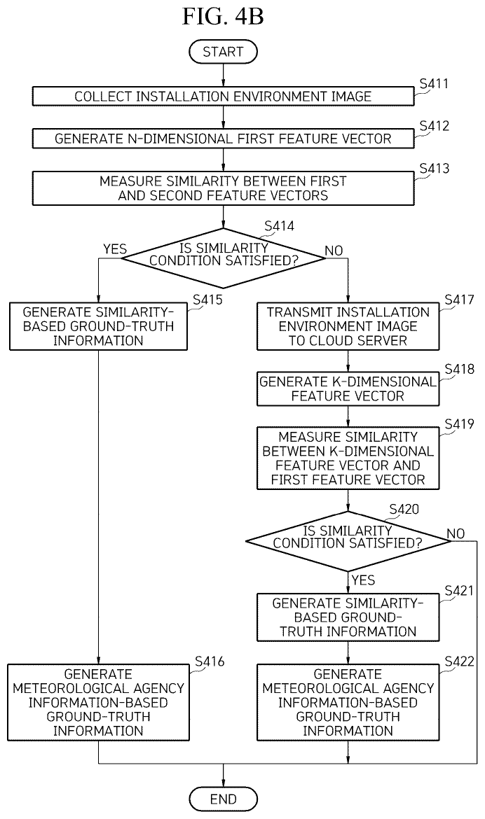

FIGS. 4A and 4B are diagrams for describing the process of generating training data when there is meteorological agency information in an embodiment of the present disclosure. In this case, in an embodiment of the present disclosure, even when there is meteorological agency information, as in the embodiments of FIGS. 3A and 3B, the training data generation process operates differently according to either the operating conditions of the edge computing device 100 environment (see FIG. 4A) or the operating conditions of the edge computing device 100 and the cloud server environment (see FIG. 4B).

First, referring to FIG. 4A, an installation environment image I is collected (S401), and an N-dimensional first feature vector is generated using the weather classification deep learning model and the dimension reduction method (S402). Next, the similarity between the probability distributions (KL divergence) of the information of the generated first feature vector and the information of the second feature vector stored in the feature space database is measured (S403). Next, it is determined whether the similarity the information of between the first and second feature vectors satisfies the preset conditions (S404), and when the determination result is that the preset conditions are satisfied, the ground-truth information based on the similarity may be generated (S405). These operations S401 to S405 are identical to the operations S301 to S305 described above.

In addition, in an embodiment of the present disclosure, the weather information of the meteorological agency measured to be the closest distance based on the installation environment may be set as the meteorological agency information-based ground-truth label [label_{location}], and the meteorological agency information-based reliability [w_{Location}] may be calculated by applying distance information D based on the location information of the installation environment and the location information corresponding to the closest distance and a predetermined weight w_{D} (S406). In this case, the distance information D is a function that measures a distance based on latitude and longitude, latₚ₁ and longₚ₁ denote the latitude and longitude at which the meteorological agency information is measured, and latₚ₂ and longₚ₂ denote the latitude and longitude in the installation environment.

$${w}_{Location} = {w}_{D} * \frac{1}{D ( {lat}_{p 1} , {long}_{p 1} , {lat}_{p 2} , {long}_{p 2} )} \qquad EQUATION 3$$

Next, referring to FIG. 4B, in the case of the operating environment conditions of the edge computing device 100 and the cloud server, a process from an operation of collecting an installation environment image to an operation of generating meteorological agency information-based ground-truth information (S411 to S416) operates in the same manner as FIG. 4A.

In addition, when the preset similarity condition is not satisfied, a process from operations (S417 to S421) of generating the similarity-based ground-truth information using the weather classification deep learning model of the cloud server is the same as in FIG. 3B, and when there is meteorological agency information, a process of generating the meteorological agency information-based ground-truth information is added in operation S422.

Referring back to FIG. 1, when the generation of the training data is completed, the deep learning model is trained and generated based on the generated training data (S140).

In operation S140, N images are collected by repeating the operation S130 described above, and the weather classification deep learning model may be trained using the collected training data. In this case, the reliability of the generated training data may be reflected and trained using all the training data L and W collected during the training.

Meanwhile, the loss function used in the process of training the deep learning model using the training data is as shown in Equations 4 and 5. In this case, Equation 4 is the loss function in the case where there is no meteorological agency information, and Equation 5 is the loss function in the case where there is meteorological agency information.

First, referring to Equation 4, in the case where there is no meteorological agency information, the deep learning model may be trained through the loss function Loss calculated by applying the reliability to the difference between a ground-truth label label_{KL} and a predicted value p_{predict} of the deep learning model.

$$Loss = {w}_{KL} * ( {label}_{KL} - {p}_{predict} ) \qquad EQUATION 4$$

Referring to Equation 5, in the case where there is meteorological agency information, the reliability w_{KL} is applied to the difference between the ground-truth label label_{KL} and the predicted value p_{predict} of the deep learning model, and the meteorological agency information-based reliability w_{location} is applied to the difference between the meteorological agency information-based ground-truth label label_{location} and the predicted value p_{predict} of the deep learning model, and then the deep learning model may be trained through the loss function Loss that adds up the application results.

$$Loss = {w}_{KL} * ( {label}_{KL} - {p}_{predict} ) + {w}_{Location} * ( {label}_{Location} - {p}_{predict} ) \qquad EQUATION 5$$

When the training of the deep learning model is completed, the existing deep learning model applied to the edge computing device 100 is updated with the generated deep learning model (S150).

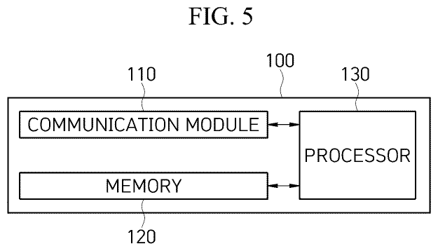

Meanwhile, in the above description, operations S110 to S422 may be further divided into additional steps or combined into fewer steps according to an implementation example of the present disclosure. In addition, some steps may be omitted if necessary, and an order between the steps may be changed. In addition, even when other details are omitted, the content described in FIGS. 1 to 4B is also applicable to the edge computing device 100 of FIG. 5.

FIG. 5 is a block diagram of an edge computing device 100 capable of optimizing a deep learning model according to an embodiment of the present disclosure.

The edge computing device 100 according to an embodiment of the present disclosure includes a communication module 110, a memory 120, and a processor 130.

The communication module 110 collects data from an installation environment through a predetermined network. The communication module 110 may include both a wired communication module and a wireless communication module. The wired communication module may be implemented as a power line communication device, a telephone line communication device, cable home (MoCA), Ethernet, IEEE1294, an integrated wired home network, and an RS-485 control device. In addition, the wireless communication module may be configured in a module for implementing functions such as wireless LAN (WLAN), Bluetooth, HDR WPAN, UWB, ZigBee, Impulse Radio, 60 GHz WPAN, Binary-CDMA, wireless USB technology and wireless HDMI technology, 5^{th} (5G) generation communication, Long Term Evolution-Advanced (LTE-A), Long Term Evolution (LTE), and wireless fidelity (Wi-Fi).

A program for training and generating a deep learning model based on data is stored in the memory 120, and the processor 130 executes the program stored in the memory 120. Here, the memory 120 collectively refers to a non-volatile storage device that continuously maintains stored information even when power is not supplied and a volatile storage device.

For example, the memory 120 may include NAND flash memories such as a compact flash (CF) card, a secure digital (SD) card, a memory stick, a solid-state drive (SSD), and a micro SD card, magnetic computer storage devices such as a hard disk drive (HDD), optical disc drives such as a compact disc read-only memory (CD-ROM) and a digital versatile disk (DVD)-ROM, etc.

The processor 130 measures the similarity between the data collected from the installation environment and the training data used for training the deep learning model by executing the program stored in the memory 120, and when it is determined that the deep learning model needs to be optimized as the measurement result of the similarity, the training data for optimization of the deep learning model is generated based on the reliability information. The processor 130 trains and generates the deep learning model based on the training data and then optimizes the existing deep learning model by updating the existing deep learning model with the generated deep learning model.

The method of optimizing a deep learning model according to the embodiment of the present disclosure described above may be implemented as a program (or application) to be executed in conjunction with hardware, such as a server, and stored on a medium.

In order for the computer to read the program and execute the methods implemented as the program, the program may include a code coded in a computer language such as C, C++, JAVA, Ruby, or machine language that the processor (CPU) of the computer may read through a device interface of the computer. Such code may include functional code related to a function or such defining functions necessary for executing the methods and include execution-procedure-related control code necessary for the processor of the computer to execute the functions according to a predetermined procedure. In addition, the code may further include memory-reference-related code indicating a location (address street number) in an internal or external memory of the computer to be referenced for the additional information or media necessary for the processor of the computer to execute the functions. In addition, when the processor of the computer needs to communicate with any other computers, servers, or the like located remotely in order to execute the above functions, the code may further include communication-related code for how to communicate with any other computers, servers, or the like using the communication module of the computer, what information or media to transmit/receive during communication, and the like.

The storage medium is not a medium that stores images therein for a while, such as a register, a cache, a memory, or the like, but a medium that semi-permanently stores the images therein and is readable by an apparatus. Specifically, examples of the storage medium include, but are not limited to, a read only memory (ROM), a random-access memory (RAM), a CD-ROM, a magnetic tape, a floppy disk, an optical image storage device, and the like. That is, the program may be stored in various recording media on various servers accessible by the computer or in various recording media on the computer of the user. In addition, media may be distributed in a computer system connected by a network, and a computer-readable code may be stored in a distributed manner.

Operations of the method or algorithm described with reference to the embodiment of the present disclosure may be directly implemented in hardware, in software modules executed by hardware, or in a combination thereof. The software module may reside in a RAM, a ROM, an erasable programmable ROM (EPROM), an electrically erasable programmable ROM (EEPROM), a flash memory, a hard disk, a removable disk, a compact disc read-only memory (CD-ROM), or in any form of computer-readable recording medium known in the art to which the invention pertains.

Although exemplary embodiments of the present disclosure have been described with reference to the accompanying drawings, those skilled in the art to which the present disclosure belongs will appreciate that various modifications and alterations may be made without departing from the spirit or essential feature of the present disclosure. Therefore, it is to be understood that embodiments described hereinabove are illustrative rather than being restrictive in all aspects.

What is claimed is:

1. A method of optimizing a deep learning model, which is performed by an edge computing device, comprising:
measuring a similarity between data collected from an installation environment of the edge computing device and training data used for training a deep learning model installed in the edge computing device;
determining whether to perform optimization of the deep learning model based on a measurement result of the similarity;
generating training data for performing the optimization of the deep learning model based on reliability information;
training and generating a deep learning model based on the training data; and
updating the existing deep learning model applied to the edge computing device with the generated deep learning model.

2. The method of claim 1, wherein the deep learning model comprises a weather classification deep learning model.

3. The method of claim 1, wherein the measuring comprises:
inputting an image collected from the installation environment into a weather classification deep learning model to extract a first feature vector;
reducing dimensions of the first feature vector and mapping the dimensions onto a first feature space; and
measuring a similarity by comparing information of the mapped first feature vector with information of a second feature vector stored in a feature space database that is built in advance.

4. The method of claim 3, wherein the measuring comprises:
inputting an image used in the training to the weather classification deep learning model to extract the second feature vector;
reducing dimensions of the second feature vector and mapping the dimensions onto a first feature space; and
storing information of the mapped second feature vector in the feature space database.

5. The method of claim 3, wherein, in generating the training data for performing the optimization of the deep learning model based on the reliability information,
similarity-based ground-truth information is generated when the similarity of the information between the first and second feature vectors satisfies a preset condition, and
the training data comprises the image collected from the installation environment, and the similarity-based ground-truth information including a classification class ground-truth label and reliability of the image.

6. The method of claim 5, wherein, in generating the training data for performing the optimization of the deep learning model based on the reliability information,
the ground-truth label directly uses a ground-truth class of training data that satisfies the preset condition, and as the reliability, reliability determined based on a maximum threshold value of relative entropy (KL-divergence) and a probability similarity of the first and second feature vectors is applied.

7. The method of claim 5, wherein the generating comprises:
in the case of an operating condition of the edge computing device and a cloud server,
in response to the similarity not satisfying the preset condition, inputting the image collected from the installation environment to the weather classification deep learning model trained with predetermined large-scale and multiple-domain-based training data from the cloud server to generate a K-dimensional (K is a natural number) feature vector, and comparing the K-dimensional feature vector with the first feature vector to generate ground-truth information based on a most similar feature vector.

8. The method of claim 5, wherein training and generating the deep learning model based on the training data includes training the deep learning model based on a loss function that applies the reliability to a difference between the ground-truth label and a predicted value of the deep learning model.

9. The method of claim 5, wherein the generating comprises:
setting weather information of a meteorological agency measured at a closest distance based on the installation environment as a meteorological agency information-based ground-truth label;
calculating meteorological agency information-based reliability by applying distance information and a predetermined weight based on location information of the installation environment and location information corresponding to the closest distance; and
generating the meteorological agency information-based ground-truth label and the meteorological agency information-based reliability as the meteorological agency information-based ground-truth information.

10. The method of claim 9, wherein training and generating the deep learning model based on the training data includes:
applying the reliability to the difference between the ground-truth label and the predicted value of the deep learning model;
applying the meteorological agency information-based reliability to a difference between the meteorological agency information-based ground-truth label and the predicted value of the deep learning model; and
training the deep learning model based on a loss function that sums up results of the application.

11. An edge computing device comprising:
a communication module configured to collect data in an installation environment through a predetermined network;
a memory configured to store a program for training and generating a deep learning model; and
a processor configured to executes the program stored in the memory to:
measure a similarity between data collected from an installation environment of the edge computing device and training data used for training a deep learning model installed in the edge computing device;
determine whether to perform optimization of the deep learning model based on a measurement result of the similarity;
generate training data for performing the optimization of the deep learning model based on reliability information;
train and generate a deep learning model based on the training data; and
update the existing deep learning model applied to the edge computing device with the generated deep learning model.
